(19) United States
(12) Patent Application Publication
(10) Pub. No.: US 2026/0311717 A1
(43) Pub. Date: Oct. 8, 2026

(54) SOUND CLASSIFICATION IN NOISY ENVIRONMENTS

(71) Applicant: Telefonaktiebolaget LM Ericsson (publ), Stockholm (SE)

(72) Inventors: Stefan ADALBJÖRNSSON, Austin, TX (US); Henrik SJÖLAND, LUND (SE); Oscar NOVO DIAZ, Vilassar de Mar (ES)

(73) Assignee: Telefonaktiebolaget LM Ericsson (publ), Stockholm (SE)

(21) Appl. No.: 19/480,641

(22) PCT Filed: May 4, 2023
(86) PCT No.: PCT/SE2023/050435

§ 371 Date: Oct. 31, 2025

(51) Int. Cl. G10L 21/0208; G10L 17/06

(52) U.S. Cl. CPC G10L 21/0208; G10L 17/06

(57) ABSTRACT

A wearable device arranged to be worn by a user. The wearable device comprises a processing circuitry or the wearable device is operatively connectible to a cloud, and configured to acquire, from at least one microphone at least one sound signal (S) indicative of a sound environment in the vicinity of the user, and to acquire, from at least one sensor a visual sensor reading (V) indicative of a visual environment and/or a movement sensor reading (M) indicative of a movement in the vicinity of the user. Thus, at least one sound source (SoS) is identified and classified as a wanted sound source (WSoS) or an unwanted sound source (USoS) from acquired input data, the acquired input data being based on one or more of: the at least one sound signal (S), the visual sensor reading (V) and the movement sensor reading (M).

### TECHNICAL FIELD

Embodiments presented herein relate to a device, method, computer program, computer program product and an apparatus for sound enhancement in the vicinity of a user by means of a technical device worn by the user.

### BACKGROUND

In recent years, automatic speech recognition has become a fundamental technology for solving many real-world problems. For example, several application programming interface (API) solutions are readily available to be integrated into various software solutions for devices with access to the Internet. Such API solutions have been combined with technology, e.g., in augmented reality (AR) glasses for visualization of translated speech (see U.S. Pat. No. 10,812,422 B2).

### SUMMARY

At present, automatic speech recognition software is not able to manage the problem of the so-called cocktail party effect, which refers to the ability for the human brain to hear selectively, i.e., to pay attention to a single auditory stimulus, e.g., a conversation, while filtering out a combination of diffuse background noise, music, and multiple simultaneous conversations. This is also an issue for hearing aids, since the human ability to perform such filtering is diminished when the received sound signal is amplified. Since the positioning of the hearing aids relative to each other is approximately known (i.e., each hearing aid is placed in or on a human ear), it is possible to beamform in the forward direction of the gaze of the user and thus improve the sound-to-noise ratio (SNR) of the desired signal.

Consequently, there is a need for improved and reliable devices and methods for sound enhancement in the vicinity of a user, e.g., in a technical device worn by the user.

Embodiments presented herein relate to a device, method, computer program, computer program product and an apparatus for sound enhancement in the vicinity of a user by means of a technical device worn by the user. It should be appreciated that these embodiments can be implemented in numerous ways. Several of these embodiments are described below.

According to a first aspect there is presented a wearable device arranged to be worn by a user. The wearable device comprises a processing circuitry or the wearable device is operatively connectible to a cloud, the wearable device being adapted to acquire, from at least one microphone operatively connected to the wearable device, at least one sound signal indicative of a sound environment in the vicinity of the user. The processing circuitry or the cloud is adapted to acquire, from at least one sensor operatively connected to the wearable device, a visual sensor reading indicative of a visual environment in the vicinity of the user and/or a movement sensor reading indicative of a movement in the vicinity of the user. The processing circuitry or the cloud is adapted to identify, from one or more of: the at least one sound signal, the visual sensor reading and the movement sensor reading, at least one sound source in the vicinity of the user. The processing circuitry or the cloud is adapted to classify the at least one sound source as a wanted sound source or an unwanted sound source from acquired input data, the acquired input data being based on one or more of: the at least one sound signal, the visual sensor reading and the movement sensor reading.

According to a second aspect there is presented a method for preferred-speaker sound enhancement in vicinity of a user wearing a wearable device. The method comprises acquiring, from at least one microphone operatively connected to the wearable device, at least one sound signal indicative of a sound environment in the vicinity of the user. The method comprises acquiring, from at least one sensor operatively connected to the wearable device, a visual sensor reading indicative of a visual environment in the vicinity of the user and/or a movement sensor reading indicative of a movement in the vicinity of the user. The method comprises identifying, from one or more of: the at least one sound signal, the visual sensor reading and the movement sensor reading, at least one sound source in the vicinity of the user. The method comprises classifying the at least one sound source as a wanted sound source or an unwanted sound source from acquired input data, the acquired input data being based on one or more of: the at least one sound signal, the visual sensor reading and the movement sensor reading.

According to a third aspect there is presented an apparatus configured to perform the method according to the second aspect.

According to a fourth aspect there is presented a computer program comprising instructions, which when executed by processing circuitry or a cloud, carries out the method according to the second aspect.

According to a fifth aspect there is presented a computer program product comprising a non-transitory storage medium including program code to be executed by a processing circuitry of a wearable device or a cloud operatively connected to the wearable device, whereby execution of the program code causes the wearable device to perform operations comprising acquiring, from at least one microphone operatively connected to the wearable device, at least one sound signal indicative of a sound environment in the vicinity of a user as well as acquiring, from at least one sensor operatively connected to the wearable device, a visual sensor reading indicative of a visual environment in the vicinity of the user and/or a movement sensor reading indicative of a movement in the vicinity of the user. The operations comprise identifying, from one or more of: the at least one sound signal, the visual sensor reading and the movement sensor reading, at least one sound source in the vicinity of the user. The operations comprise classifying the at least one sound source as a wanted sound source or an unwanted sound source from acquired input data, the acquired input data being based on one or more of: the at least one sound signal, the visual sensor reading and the movement sensor reading.

These aspects provide embodiments for sound enhancement in the vicinity of a user by means of a technical device worn by the user. Other objectives, features and advantages of the enclosed embodiments will be apparent from the following detailed description, from the attached dependent claims as well as from the drawings.

### BRIEF DESCRIPTION OF THE DRAWINGS

FIG. 1 is showing a user who is wearing a wearable device for preferred-speaker sound enhancement in the vicinity of a user by means of a technical device worn by the user.

FIG. 2 is showing functional units of the method for sound enhancement in the vicinity of a user by means of a technical device worn by the user, according to an embodiment of the disclosure.

FIG. 3 is showing a computer program product and a computer program, according to an embodiment of the disclosure.

### DETAILED DESCRIPTION

The current disclosure concerns a wearable device 100, method 110 and computer program product for speech/sound enhancement, e.g., for facilitating sufficient speech/sound loudness or sound pressure level (SPL) for a preferred speaker or sound source SoS in order to improve, i.a., speech intelligibility in a noisy environment.

The disadvantages with current technology for sound enhancement are, for example:
The accuracy of automatic speech recognition is severely degraded in scenarios such as the cocktail party scenario.
In a noisy environment, the human ear will become desensitized while a microphone measured response will satisfy the super-position principle to a larger extent. However, the ability of a human being to filter out a relevant speaker sound outweighs the ability of state-of-the-art machine learning algorithms.
Currently, microphones from other users or devices are not used for signal enhancement despite the evidence for improved performance with more spatial diversity.
The user's intention to listen to a specific speaker or a specific source of sound cannot be easily exploited for beamforming as the relative orientation between beamforming direction and gaze is unknown.
The beamforming commonly used for directivity in hearing aids has a broad beam width and is not adaptive to the intent of the wearer.
Sound fidelity and subsequent processing performance can be improved by attenuating unwanted signals from specific directions. However, the directions are not known.
Maps with locations of sound sources can be created using simultaneous localization and mapping (SLAM) and microphone sensors. However, the current state-of-the-art methods can only naively make use of them for signal enhancement and do not exploit the possibility of using technology such as AR glasses as a user interface for classification.

The aim of embodiments presented herein is to improve preferred-speaker sound enhancement in the vicinity of a user by means of a technical device worn by the user.

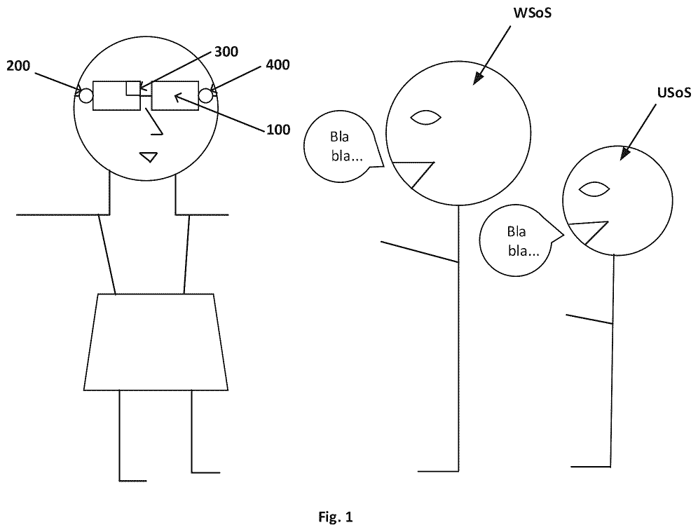

FIG. 1 illustrates a user who is wearing a wearable device 100 for sound enhancement in the vicinity of the user, in accordance with embodiments of the invention. The wearable device 100 comprises a processing circuitry or the wearable device 100 is operatively connectible to a cloud, the wearable device 100 being adapted to acquire a sound signal S indicative of a sound environment in the vicinity of the user. The sound signal S is acquired from at least one microphone 200, which is operatively connected to the wearable device 100. The processing circuitry or the cloud is further adapted to acquire a visual sensor reading V indicative of a visual environment in the vicinity of the user and/or a movement sensor reading M indicative of a movement in the vicinity of the user. The visual sensor reading V and/or the movement sensor reading M is acquired from at least one sensor 300 which is operatively connected to the wearable device 100. The processing circuitry or the cloud is further adapted to identify from one or more of: the at least one sound signal S, the visual sensor reading V and the movement sensor reading M, at least one sound source SoS in the vicinity of the user. The processing circuitry or the cloud is adapted to classify the at least one sound source SoS as a wanted sound source WSoS or an unwanted sound source USoS from acquired input data, the acquired input data being based on one or more of: the at least one sound signal S, the visual sensor reading V and the movement sensor reading M.

The user may be a pedestrian, a person (i.e., a human being), a robot or an animal, e.g., a monkey or a dog.

The wearable device 100 may comprise one of a helmet, a hat, a headset, earphones, augmented reality glasses, and virtual reality glasses.

The vicinity of the user is defined as the area in front of the user (or the area in every direction around the user) within the range of 0 -10 meters, preferably within the range of 0-5 meters and even more preferably within the range of 0-2 meters.

The at least one sound signal S, as well as the at least one sound source SoS, may be produced by a speaker, i.e., a person (i.e., a human being), a robot or an animal, e.g., a monkey or parrot, by sirens from emergency vehicles, music, traffic, home appliances, running water, etc.

The at least one sensor 300, providing a visual sensor reading V indicative of a visual environment in the vicinity of the user and/or a movement sensor reading M indicative of a movement in the vicinity of the user, may be any of camera (e.g., an event camera or a stereo camera), a 3D sensor, a contour sensor, an accelerometer, a gyroscope, an eye tracker, a passive infrared sensor, an ultrasonic sensor, a microwave sensor, an RGB-D sensor, a RADAR, a Wi-Fi, a 5G modem, a sonar, a lidar, a compass, or a tomographic sensor. A gyroscope is a device used for measuring orientation and angular velocity. An RGB-D sensor is a specific type of depth-sensing device that works in association with an RGB (red, green and blue color) sensor camera. The movement sensor reading M could relate to hand movements, head movements, eye movements or other so-called internal movements by the user, or mouth movements of a speaker, thus indicating that the speaker is speaking, or other external movements indicating that a speaker or other sound source SoS is approaching or moving away from the user. The wearable device 100 can also not comprise a sensor 300, according to embodiments of the invention.

### Acquired Input Data and Classification

The processing circuitry or the cloud is adapted to classify the at least one sound source SoS as a wanted sound source WSoS or an unwanted sound source USoS from the acquired input data, either automatically (e.g., from machine learning algorithms) or manually by input (e.g., gestures) from the user.

The acquired input data is based on one or more of: the at least one sound signal S, the visual sensor reading V and the movement sensor reading M. In some embodiments, the acquired input data can be based on the at least one sound signal S only. In other embodiments, the acquired input data can be based on two or more of: the at least one sound signal S, the visual sensor reading V and the movement sensor reading M.

In other embodiments, the acquired input data may be at least one of: input classification data from a classifying machine learning algorithm (i.e., automatic classification), and a manual classification signal produced by the user. The input classification data from a classifying machine learning algorithm is based on one or more of: the at least one sound signal S, the visual sensor reading V and the movement sensor reading M. The speech identified from the sound signal S can be further analyzed to match two separate speakers as being highly likely to be in the same conversation based on the content of their speech, pauses in their conversations when other conversational partners are speaking, as well as shared laughs. The resulting classification can be intuitively displayed for the user of the wearable device 100, e.g., a bounding box can turn red for unwanted sound source/s USoS and turn green for wanted sound source/s WSoS.

If the user wants to correct a classification by a manual classification signal, the color of the bounding box can gradually change as the user's intentions indicate, e.g., the user's gaze at an unwanted sound source USoS correlated with the user's nodding his/her head may gradually change the bounding box from red to green. Else, the manual classification signal produced by the user, for example with the purpose of changing the volume, loudness or sound pressure level (SPL) of the at least one sound source SoS, may be any of a head movement, hand movement or an eye movement of the user picked up by the at least one sensor 300, or a vocal sound by the user picked up by the at least one microphone 200. Thus, the gestures made by the user can be with his/her head (nodding, tilting, shaking, etc.), his/her hand (thumb up/down, etc.) or his/her eye/s (long blink with one or two eyes, etc.). The manual classification signal may be registered, i.a., by an accelerometer 300 to detect hand movements of the user, a camera 300 to detect hand gestures of the user, an eye tracker 300 to detect eye gaze (e.g., the user looking in the direction of the sound source SoS for a prolonged amount of time, such as when engaging in conversation) and/or eye blinking of the user, and/or an at least one microphone 200 to detect vocal commands made by the user. In other embodiments, the user can indicate a focused conversation mode with a single speaker by holding up his/her finger while looking at the single speaker or indicate a group conversation mode by holding up several of his/her fingers. The manual classification signal produced by the user, e.g., manual gestures by the user, may be used for training the machine learning algorithms used for automatic classification. Furthermore, the manual classification signal produced by the user may be a primary mode of classifying the at least one sound source SoS as a wanted sound source WSoS or an unwanted sound source USoS, thus overriding the automatically determined classification.

In another embodiment, the sound pressure level (SPL) or loudness of the at least one sound source SoS classified as a wanted sound source WSoS is increased by a determined increase level. In another embodiment, the sound pressure level (SPL) or loudness of an at least one sound source SoS classified as an unwanted sound source USoS is decreased by a determined decrease level.

Loudness is the subjective perception of sound pressure, more formally defined as the attribute of auditory sensation in terms of which sounds can be ordered on a scale extending from quiet to loud. For the human ear, the perceived loudness of a sound depends on its fundamental frequency (f₀), its sound pressure level (dB SPL), as well as various subjective factors.

The determined increase level is defined as the increase in sound pressure level (dB SPL or a weighted SPL level, e.g., A-weighted SPL (dBA)) or loudness for the preferred speaker/sound that has been determined automatically or manually by the user, e.g., by the user pushing a button or switch operatively connected to the wearable device 100, or by the user making a gesture for volume adjustment of the preferred speaker/sound. The determined increase level can be within the range of 3-30 dB SPL, preferably within the range of 5-20 dB SPL and even more preferably within the range of 6-12 dB SPL, e.g., per pushed button or switch.

Similarly, the determined decrease level is defined as the decrease in sound pressure level (dB SPL or a weighted SPL level, e.g., A-weighted SPL (dBA)) or loudness for the unwanted speaker/s or sound/s that has been determined automatically or manually by the user, e.g., by the user pushing a button or switch operatively connected to the wearable device 100, or by the user making a gesture for volume adjustment of the unwanted speaker/s or sound/s. The determined decrease level can be within the range of 3-30 dB SPL, preferably within the range of 5-20 dB SPL and even more preferably within the range of 6-12 dB SPL, e.g., per pushed button or switch.

Machine learning algorithms may be used for determining the determined increase level and/or the determined decrease level based on one or more of: the at least one sound signal S, the visual sensor reading V and the movement sensor reading M.

### Speaker/Sound Lists and Speech Content

In some embodiments, a database or list of speakers classified as wanted (or unwanted) by default can be created. The wanted (or unwanted) speaker/s is/are identified by obtaining vocal data from the at least one sound signal S and/or by facial data from the at least one sensor 300 and thereafter comparing the obtained vocal data and/or facial data with vocal data and/or facial data stored in the wanted speaker's list or unwanted speaker's list. In other words, vocal data is used for voice recognition of a speaker, and facial data is used for face or visual recognition of a speaker. Additionally, sound lists of wanted and/or unwanted sounds can be created for automatic classification, containing, e.g., crying babies or commonly occurring nuisance noises such as drilling, dog barking, or sirens. Likewise, sound lists of wanted and/or unwanted sounds can be populated by collecting statistics of labels classified manually.

Automatic classification of the at least one sound source SoS as unwanted USoS or wanted WSoS may also be based on speech content of the at least one speaker in the vicinity of the user. For example, certain words or sounds may immediately classify the at least one sound source SoS as unwanted USoS or wanted WSoS. Such words could be the user's name or a warning. Furthermore, the suppression (e.g., decrease in sound pressure level) of an at least one sound source SoS could be indicated by the user by making a “sssh” sound or using the word “quiet”. In another embodiment, certain keywords may also be learned automatically. When a certain keyword is used, e.g., speaking the name of the user's pet, the speaker of the keyword may be added as a wanted sound source WSoS. Accordingly, a database or list of the user's favorite topics may be created and used for this purpose.

### Beamforming

In an embodiment, the wearable device 100 is adapted to perform beamforming for determining the direction of and to spatially filter out the sound of the at least one sound source SoS. This beamforming information can be used by the wearable device 100 that is further adapted to perform 3D mapping of the at least one sound source SoS.

Beamforming or spatial filtering is a signal processing technique whereby radio or sound signals can be steered in a specific direction, undesirable interference sources can be suppressed and/or the signal-to-noise ratio (SNR) of received signals can be improved. Beamforming is widely used in, e.g., radars and sonar systems, biomedical, and particularly in communications (telecom, Wi-Fi), specially 5G.

In general terms, beamforming can be used in sensor arrays for directional signal transmission or reception. This is achieved by combining elements in an antenna array in such a way that signals at particular angles experience constructive interference while others experience destructive interference. Beamforming can be used at both the transmitting and receiving ends in order to achieve spatial selectivity. The improvement compared with omnidirectional reception/transmission is known as the directivity of the array.

State-of-the-art methods exist such that if the angle of arrival of an unwanted sound source is known, it can be dampened by creating a spatial filter that maintains the main beam in the direction towards the wanted sound source while attenuating the unwanted sound source/s. A typical example of such a system would maintain a beam straight ahead as a proxy for direction of a wanted sound source while using signal processing techniques to adaptively estimate the angle of arrival of unwanted sound source/s.

Certain combinations of microphone placements and machine learning algorithms improve positively the speech signal quality using traditional beamforming techniques. In this disclosure, by performing beamforming, i.e., carry out the signal processing technique of beamforming, the direction of the at least one sound source SoS can be determined in current embodiments. In order to perform beamforming for determining the direction of the at least one sound source SoS, a microphone array 200, 400 is needed. In order to determine the direction of audible sound, it is typically sufficient to use one microphone on each of the two opposite sides of the user's head, i.e., at least two microphones or a microphone array comprising at least two microphones 200, 400. By positioning microphones 200, 400 on the wearable device 100 and allowing for joint processing of signals from several nearby devices (e.g., mobile phones or conference room microphones in the vicinity of the user), the signal fidelity can be improved, e.g., with non-coherent integration of each sound source's beamformed signal or by estimating the most probable sentence using the output from the speech-to-text algorithm of each nearby device. Communication between the nearby devices allows the best combination of microphones in the vicinity of the user to be employed while avoiding microphones that mostly contribute with noise.

In some embodiments, the wearable device 100 is fitted with microphones 200, 400 as in FIG. 1. The received sound by the microphones 200, 400 will be beamformed to allow for improved signal quality in the direction of the wanted signal source/s WSoS. To find the direction of the wanted signal source/s WSoS, possible sound sources can be visually identified based on the visual sensor reading V and the position of the wearable device 100 can be used to indicate that it is a wanted signal source WSoS. A simple realization would decide the sound source SoS as wanted if the total time for which the wearable device 100 is approximately centered on the sound source SoS exceeds such time estimates for other sound sources. A more complicated realization would take into account that a speaker in the vicinity of the user will normally take turns when speaking and, as a consequence, a wanted sound source WSoS would not so easily be removed during a time interval of silence. An even more advanced realization would also attempt to interpret the intent of the user and quickly add a new wanted sound source WSoS when a new speaker joins in the conversation, the latter of which could be indicated by an obvious change in position of the wearable device 100 as the user looks in the direction of the new speaker.

For the beamforming, the direction to the sound source/s SoS must be known relative to the wearable device 100. This estimate can be made based on the visual sensor reading V. Firstly, a computer vision algorithm can identify possible sound source/s SoS. Secondly, the total time each of the sound source/s SoS is in focus is estimated. The relative direction to the sound sources found in such a manner is easily found and tracked using SLAM methods known to the skilled person. For the unwanted sound source/s USoS, the direction is found in the same manner so that the beamformer can attenuate any sound coming from that direction.

In another embodiment, two unwanted sound sources USoS are identified. The beamforming will be applied to improve the signal quality in the direction of the wanted sound source/s WSoS while attenuating the unwanted sources USoS.

### 3D Mapping

The one or more sensor/s 300, typically camera/s, which is/are connected to the wearable device 100 can be used to create a three-dimensional (3D) map in which the sound source/s SoS can be positioned, and each sound source SoS classified as wanted or unwanted. The position of the wearable device 100 may be estimated simultaneously and tracked in the same 3D map using simultaneous localization and mapping (SLAM). Most commonly, Sparse feature-based SLAM is used by resource-constrained devices such as the wearable device 100. Such algorithms create sparse 3D maps based on measurements of the relative pose changes between consecutive camera frames as well as relative measurements from the camera pose to features detected in the images and tracked across multiple images. Examples of such feature detectors include SIFT, ORB, and SURF. The relative pose changes are improved if an inertial measurement unit (IMU) measurement is also available. The resulting 3D map is an optimized estimate of the position of features and poses of the camera, using techniques such as bundle adjustment or filtering. In images where sound sources are detected and classified, e.g., using bounding boxes or semantic segmentation of the image (pixel-wise classification), the sparse features overlapping the position of the sound source in the image can be attached with meta data to indicate that it corresponds to a sound source. In this way a 3D map with the position of the sound sources can be created. 3D reconstruction can also be employed to create a dense representation of the sparse features. Besides, more elaborate techniques are available for creating dense 3D metric semantic maps. In those cases, similarly, the semantic information is based on the semantic segmentation of the 2D images.

It should be noted that, in some embodiments, one or more sensor/s 300, typically camera/s, operatively connected to the wearable device 100 can be used to map sound sources SoS with their appearance and beamforming direction maintained, even if the eye gaze of the user changes momentarily. As an alternative, a machine learning algorithm can be devised to interpret the intent of the user to decide if a new beamforming direction is wanted or the current one is to be maintained.

### Subtitles or Speech-to-Text

In some embodiments, the wearable device 100 further comprises means for displaying speech-to-text to the user, the speech-to-text being based on the at least one wanted sound source WSoS.

Speech-to-text can generally be defined as speech recognition that allows spoken words to be converted into written text, often in real-time. In embodiments of the disclosure, the speech-to-text can be presented to the user in the wearable device 100 as subtitles in real-time of the speech spoken by the speaker that is currently in focus, i.e., by the speaker that the user is looking at, for example detected by an eye tracker 300 operatively connected to the wearable device 100 worn by the user.

In case earphones/hearing aids are worn by the user, the earphones/hearing aids can be wirelessly connected to the wearable device 100 and present the beamformed sound to the user, so that the user can both hear the sound from the direction he/she focuses on and see subtitles when there is speech. When presenting the sound through earphones/hearing aids to the user, the direction of the beam should be considered using head related transfer functions (HTRFs), the latter of which generally describe how an ear receives sound from a sound source.

### Corresponding Method and Computer Program Product

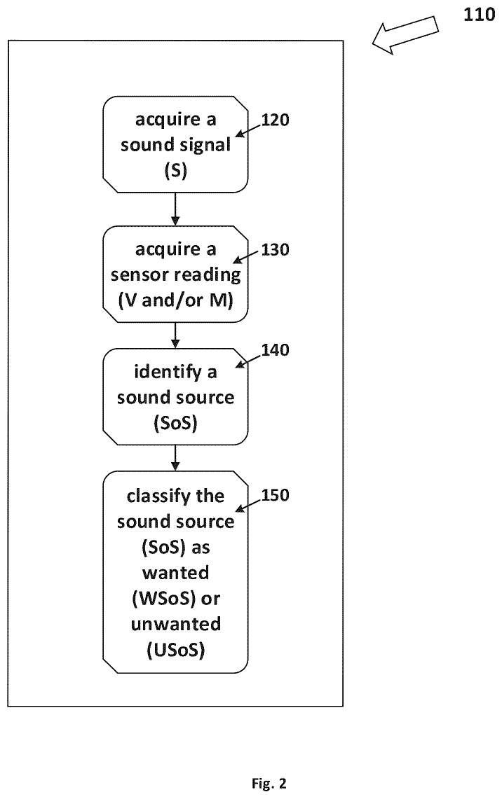

In the following text, embodiments of the method 110 for preferred-speaker sound enhancement in the vicinity of a user wearing a wearable device 100 are described with reference to FIG. 2. The method 110 comprises acquiring 120, from at least one microphone 200 operatively connected to the wearable device 100, at least one sound signal S indicative of a sound environment in the vicinity of the user. The method 110 comprises acquiring 130, from at least one sensor 300 operatively connected to the wearable device 100, a visual sensor reading V indicative of a visual environment in the vicinity of the user and/or a movement sensor reading M indicative of a movement in the vicinity of the user. The method 110 further comprises identifying 140, from one or more of: the at least one sound signal S, the visual sensor reading V and the movement sensor reading M, at least one sound source SoS in the vicinity of the user. The method 110 comprises classifying 150 the at least one sound source SoS as a wanted sound source WSoS or an unwanted sound source USoS from acquired input data, the acquired input data being based on one or more of: the at least one sound signal S, the visual sensor reading V and the movement sensor reading M.

In an embodiment, the method 110 is performed by a processing circuitry in the wearable device 100 or a cloud operatively connected to the wearable device 100. The wearable device 100 may comprise one of a helmet, a hat, a headset, earphones, augmented reality glasses, and virtual reality glasses.

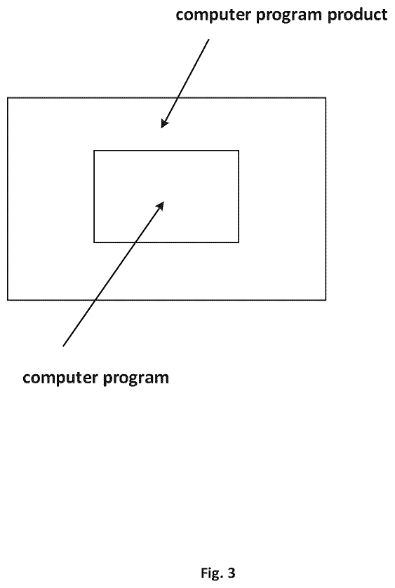

FIG. 3 illustrates a computer program C comprising instructions, which when executed by processing circuitry or a cloud, carries out the method 110.

FIG. 3 also illustrates a computer program product comprising a non-transitory storage medium including program code to be executed by a processing circuitry of a wearable device 100 or a cloud operatively connected to the wearable device 100, whereby execution of the program code causes the wearable device 100 to perform operations comprising acquiring, from at least one microphone 200 operatively connected to the wearable device 100, at least one sound signal S indicative of a sound environment in the vicinity of the user, as well as acquiring, from at least one sensor 300 operatively connected to the wearable device 100, a visual sensor reading V indicative of a visual environment in the vicinity of the user and/or a movement sensor reading M indicative of a movement in the vicinity of the user. The operations further comprising identifying, from one or more of: the at least one sound signal S, the visual sensor reading V and the movement sensor reading M, at least one sound source SoS in the vicinity of the user. The operations comprising classifying the at least one sound source SoS as a wanted sound source WSoS or an unwanted sound source USoS from acquired input data, the acquired input data being based on one or more of: the at least one sound signal S, the visual sensor reading V and the movement sensor reading M.

In an embodiment, the wearable device 100 comprises one of a helmet, a hat, a headset, earphones, augmented reality glasses, and virtual reality glasses. In another embodiment, the at least one microphone 200 is a microphone array 200, 400.

### Advantages of the Disclosure

The advantages of the embodiments described in this disclosure are, for example:
Joint processing of signal from microphones with high spatial diversity will increase the signal quality, thus making it easier to understand speech in a noisy environment and increase the performance of any solution based on speech-to-text algorithms.
The wearable device 100, e.g., AR glasses, can cooperate with wireless earphones/hearing aids so that the user is both presented with sound from the direction where he/she focuses, as well as with subtitles in case there is speech from that direction.
The AR glasses can work independently using at least one built-in microphone 200 or in cooperation with other devices with microphones to improve performance, e.g., mobile phones and dedicated devices with built-in microphone arrays used at parties and meetings. Visual cues from the AR glasses can be employed for selecting which devices with microphones to use.
The AR glasses offer many opportunities for convenient user interfaces for the control, handling, or classification of different sound sources and modes of operation, by accelerometers detecting head movements, eye trackers detecting gaze direction and blinking, microphones detecting sounds, and cameras detecting hand gestures.

1. A wearable device arranged to be worn by a user, the wearable device comprising a processing circuitry or the wearable device being operatively connectible to a cloud, the wearable device configured to perform operations comprising:
acquire, from at least one microphone operatively connected to the wearable device, at least one sound signal (S) indicative of a sound environment in the vicinity of the user;
acquire, from at least one sensor operatively connected to the wearable device, a visual sensor reading (V) indicative of a visual environment in the vicinity of the user and/or a movement sensor reading (M) indicative of a movement in the vicinity of the user;
identify, from one or more of: the at least one sound signal (S), the visual sensor reading (V) and the movement sensor reading (M), at least one sound source (SoS) in the vicinity of the user; and
classify the at least one sound source (SoS) as a wanted sound source (WSoS) or an unwanted sound source (USoS) from acquired input data, the acquired input data being based on one or more of: the at least one sound signal (S), the visual sensor reading (V) and the movement sensor reading (M).

2. The wearable device according to claim 1, wherein the wearable device comprises one of a helmet, a hat, a headset, earphones, augmented reality glasses, and virtual reality glasses.

3. The wearable device according to claim 1, wherein the acquired input data is at least one of: input classification data from a classifying machine learning algorithm and a manual classification signal produced by the user.

4. The wearable device according to claim 3, wherein the manual classification signal produced by the user is any of a head movement, hand movement or an eye movement of the user picked up by the at least one sensor, or a vocal sound by the user picked up by the at least one microphone.

5. The wearable device according to claim 3, wherein the manual classification signal produced by the user is a primary mode of classifying the at least one sound source (SoS) as a wanted sound source (WSoS) or an unwanted sound source (USoS).

6. The wearable device according to claim 1, wherein the sound pressure level (SPL) or loudness of the at least one sound source (SoS) classified as a wanted sound source (WSoS) is increased by a determined increase level.

7. The wearable device according to claim 1, wherein the sound pressure level (SPL) or loudness of an at least one sound source (SoS) classified as an unwanted sound source (USoS) is decreased by a determined decrease level.

8. The wearable device according to claim 1, wherein the at least one sensor is any of a camera, a 3D sensor, a contour sensor, an accelerometer, a gyroscope, an eye tracker, a passive infrared sensor, an ultrasonic sensor, a microwave sensor, an RGB-D sensor, a RADAR, a Wi-Fi, a 5G modem, a sonar, a lidar, a compass, or a tomographic sensor.

9. The wearable device according to claim 1, wherein the at least one microphone is a microphone array.

10. The wearable device according to claim 9, wherein the wearable device is further configured to perform beamforming for determining the direction of and to spatially filter out the sound of at least one sound source (SoS).

11. The wearable device according to claim 10, wherein the wearable device is further configured to perform 3D mapping of the at least one sound source (SoS).

12. The wearable device according to claim 1, wherein the wearable device is further configured to acquire, from vocal data of the at least one sound signal (S) and/or from facial data of the at least one sensor, vocal or facial data of at least one speaker in the vicinity of the user and compare the thus obtained vocal or facial data with a known speaker's list of obtained facial and vocal characteristics, thereby facilitating identification of at least one known speaker in the vicinity of the user.

13. The wearable device according to claim 1, wherein the wearable device is further configured to display speech-to-text to the user, the speech-to-text being based on the at least one wanted sound source (WSoS).

14. A method for preferred-speaker sound enhancement in vicinity of a user wearing a wearable device, the method comprising:
acquiring, from at least one microphone operatively connected to the wearable device, at least one sound signal (S) indicative of a sound environment in the vicinity of the user;
acquiring, from at least one sensor operatively connected to the wearable device, a visual sensor reading (V) indicative of a visual environment in the vicinity of the user and/or a movement sensor reading (M) indicative of a movement in the vicinity of the user;
identifying, from one or more of: the at least one sound signal (S), the visual sensor reading (V) and the movement sensor reading (M), at least one sound source (SoS) in the vicinity of the user; and
classifying the at least one sound source (SoS) as a wanted sound source (WSoS) or an unwanted sound source (USoS) from acquired input data, the acquired input data being based on one or more of: the at least one sound signal (S), the visual sensor reading (V) and the movement sensor reading (M).

15. The method according to claim 14, wherein the method is performed by a processing circuitry of the wearable device or a cloud operatively connected to the wearable device.

16-19. (canceled)

20. The method according to claim 14, wherein the sound pressure level (SPL) or loudness of the at least one sound source (SoS) classified as a wanted sound source (WSoS) is increased by a determined increase level.

21. The method according to claim 14, wherein the sound pressure level (SPL) or loudness of an at least one sound source (SoS) classified as an unwanted sound source (USoS) is decreased by a determined decrease level.

22. (canceled)

23. The method according to claim 14, wherein the at least one microphone is a microphone array.

24. The method according to claim 23, wherein beamforming is performed for determining the direction of at least one sound source (SoS).

25. The method according to claim 24, wherein the wearable device is further configured to perform 3D mapping of the at least one sound source (SoS).

26-32. (canceled)
